(19) United States
(12) Patent Application Publication
(10) Pub. No.: US 2014/0371793 A1
(43) Pub. Date: Dec. 18, 2014

(54) INVERTIBLE SPINAL DECOMPRESSION ROLLER TABLE

(71) Applicant: Lloyd Table Company, Lisbon, IA (US)

(72) Inventors: Lloyd A. STEFFENSMEIER, Lisbon, IA (US); George BARBOUR, Lisbon, IA (US)

(21) Appl. No.: 14/302,923

(22) Filed: Jun. 12, 2014

Related U.S. Application Data
(60) Provisional application No. 61/834,281, filed on Jun. 12, 2013.

(51) Int. Cl. A61H 1/00

(52) U.S. Cl. CPC A61H 1/008
USPC 606/244

(57) ABSTRACT

A chiropractic table has a power-operated linkage that will invert a user of the table. The table employs a foot plate which secures the user's feet. A set of rollers can rotate and massage the user and can travel the length of the user's spine. The use of the rollers while in an inverted position allows greater health benefits than while in a non-inverted position due to the decompression of the spinal cord.

### CROSS-REFERENCE TO RELATED APPLICATIONS

The present application claims priority to provisional patent application 61/834,281 which was filed on Jun. 12, 2013, and is hereby expressly incorporated by reference in its entirety.

### BACKGROUND OF THE INVENTION

There are known and commercially available to the practicing chiropractor and other health care professionals and practitioners numerous types of tables to assist the practitioner in conducting examinations, adjustments and treatments beneficial to the patient. Most tables are designed so that they can be raised and lowered to a position comfortable for the practitioner to treat the patient. Prior art tables are limited to a patient remaining in a position such that the vertebrae and spine remain in a compressed position.

It is therefore an object of the invention to provide an improved chiropractic table in which the table will position the person in an at least partially inverted position allowing the vertebrae and spine to decompress.

It is further the objection of the invention to provide an improved chiropractic table in which a set of rollers will massage the user of the table in the partially inverted position and a non-inverted position.

### SUMMARY OF THE INVENTION

The chiropractic table of the invention utilizes a padded portion supported by a pair of support members attached to a rectangular base. The table also has a foot plate which has a system for securing the user's lower legs. A user secures his feet in the footplate and then lies back on the padded portion of the table.

The user can then manipulate a set of controls mounted on the table located near where the user's arms would naturally be positioned. The controls allow the user or a person to activate a tilting mechanism which can tilt the table such that the user's legs become elevated over the user's head. The user then becomes at least partially inverted and the user's vertebrae and spine become partially decompressed or at the least less compressed than when the head is at a greater or equal height than the foot of the user.

A set of rollers is mounted just beneath the padded portion and can be manipulated by the user via the set of controls. The rollers can be directed the longitudinal length of the user's spine. Additionally, the rollers can be rotated around an axis such that the rollers push up on the padded portion and put a pressure or massaging action on the user's spine. The height of the rollers relative to the user can be modified and thus effect how much pressure is felt by the user by the rollers. Once completed, the table can be repositioned such that the user is not inverted. The user then unsecures his legs from the footplate and can remove himself from the table.

### BRIEF DESCRIPTION OF THE DRAWING

FIG. 1 is a perspective view of a table constructed according to the principles of the invention;

FIG. 2 is a top view of the foot plate portion of the table;

FIG. 3 is a perspective view of the invention showing the driving mechanism;

FIG. 4 is a side view of the foot plate portion of the table;

FIG. 5 is a top view of the invention;

FIG. 6 is a rear view of the invention;

FIG. 7 is a side view of the invention;

FIG. 8 is a front view of the invention;

FIG. 9 is a perspective view of the roller member portion of the invention.

### DESCRIPTION OF THE PREFERRED EMBODIMENT OF THE INVENTION

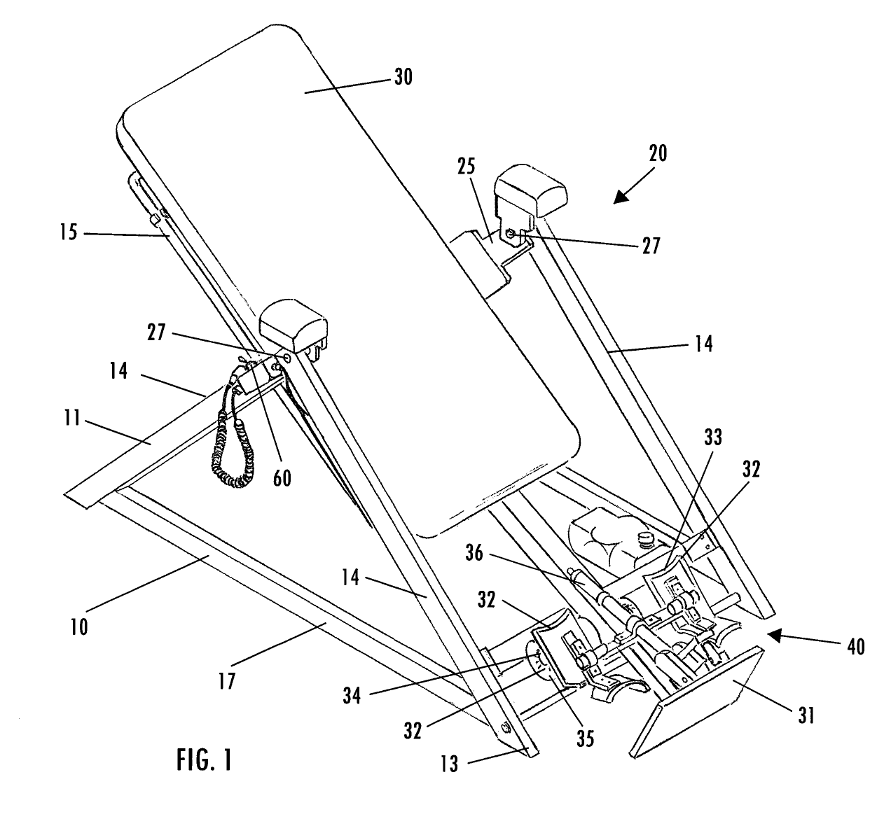

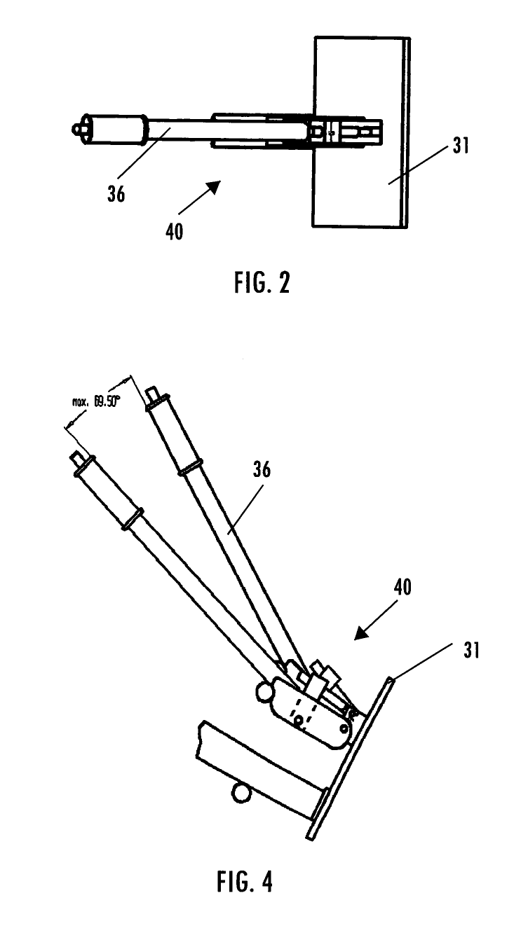

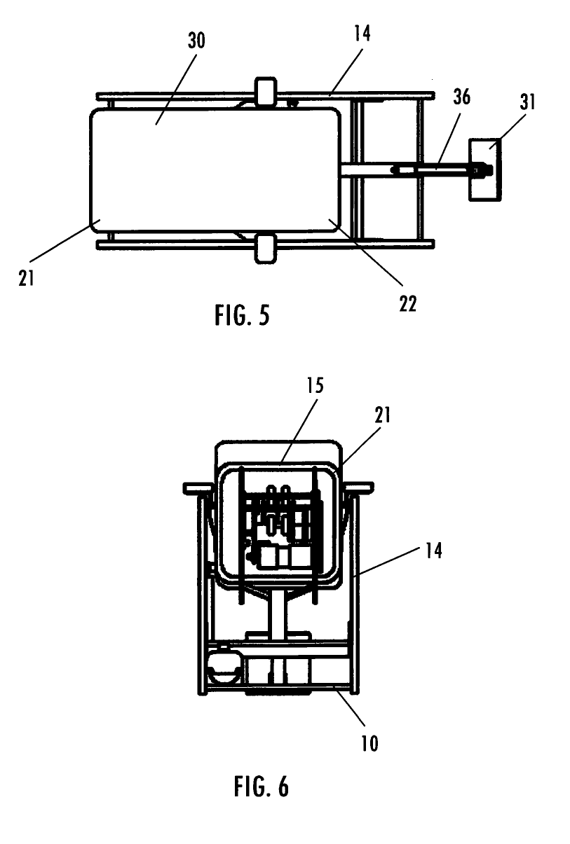

Referring first to FIGS. 1 and 5-8, the chiropractic table 20 of the invention has a base frame 10 that has a first end 11 and an opposite second end 13. The frame 10 is preferably rectangular at its base 17. A pair of casters (not shown) can be provided at the second end 13 to facilitate movement of the table 20. The base frame 10 has at least one supporting member 14 spaced apart on each side of the base frame 10 that support a patient support system 15. The supporting member 14 elevates the support system 15 from the ground such that it facilitates access to the support system 15 and allows the support system 15 to be inverted without interference from the ground.

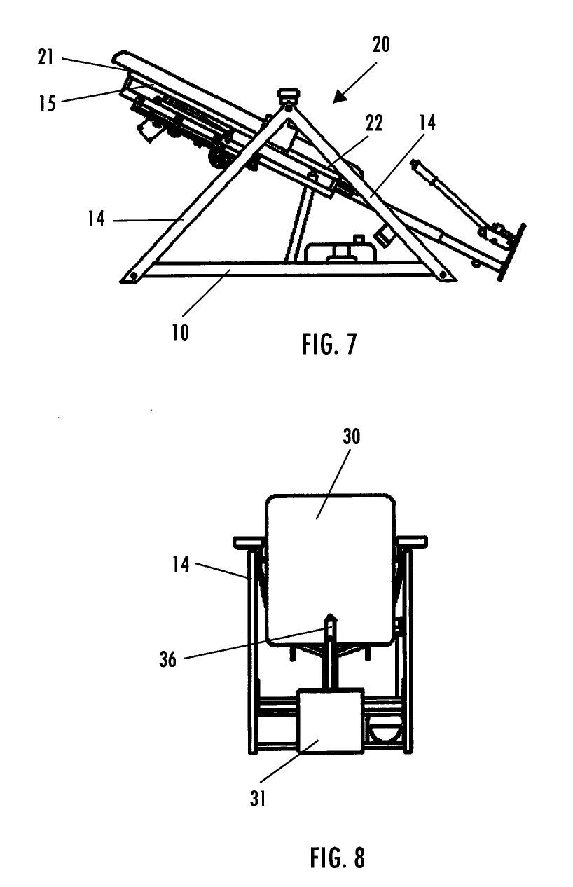

As best seen in FIG. 7, the patient support system 15 of the table 20 has a first end 21 and a second end 22. The support system 15 can be attached to a crossbar 25 which is connected to the at least one supporting member 14. In alternative embodiments, the crossbar 25 can be part of the frame 10 or the support system 15. The support system 15 is pivotable and rotatable on the stationary at least one supporting member 14, specifically around a pair of bolts 27 which connect the crossbar 25 to the supporting member 14. The support system 15 is provided with cushions 30 for the support and comfort of the patient.

At a first position of the table 20, the user's head is at the first end 21 and the user's lower legs are secured in a footplate 40. The head of the user is elevated above the user's feet while in the first position. The footplate 40 comprises a planar member 31 which allows the user to place his or her feet on. While the table 20 is in the first position, the planar member 31 assists in maintaining the user in a particular position and prevents the user from sliding down the table 20. The footplate 40 comprises a mechanism for further securing the lower legs of the user. A pair of leg capturing members 32 each has a top 33 and a bottom 34. Preferably the top 33 and 34 are shaped such that they each have a curved portion which corresponds to the top and bottom of the user's leg. Additionally the top 33 and bottom 34 preferably have padding 35 for the comfort of the user. A lever 36 actuates the footplate 40 from an open position to a closed position and vice versa as seen in FIG. 4. The user places his or her legs between the top 33 and bottom 34 of the leg capturing members 32 while in the open position. The user then manipulates the lever 36 to move the footplate 40 to the closed position which reduces the amount of space between the top 33 and bottom 34, therefore, securing the legs of the user. The footplate 40 can contain a locking mechanism to prevent the lever from moving the footplate 40 to the open position. The locking mechanism can be selectively controlled by the user.

After securing the user's lower legs as described above, the user can use a set of controls 60 to manipulate the table. Preferably the controls 60 are powered by electronically although other means of movement are certainly contemplated by the applicants. One of the controls activates an actuator which pushes the second end 22 of the table 20 along with the footplate 40 upward. The support system 15 rotates around the bolts 27, and the first end 21 becomes lower than the second end 22 and footplate 40. The user then becomes at least partially inverted. The preferred range of motion has the user beginning at 45 degrees and ending at 135 degrees, although any range is possible including ranges of 180 degrees. The preferred embodiment utilizes a motor and a mechanism such as hydraulic or pneumatic pressure to raise and lower the second end 22.

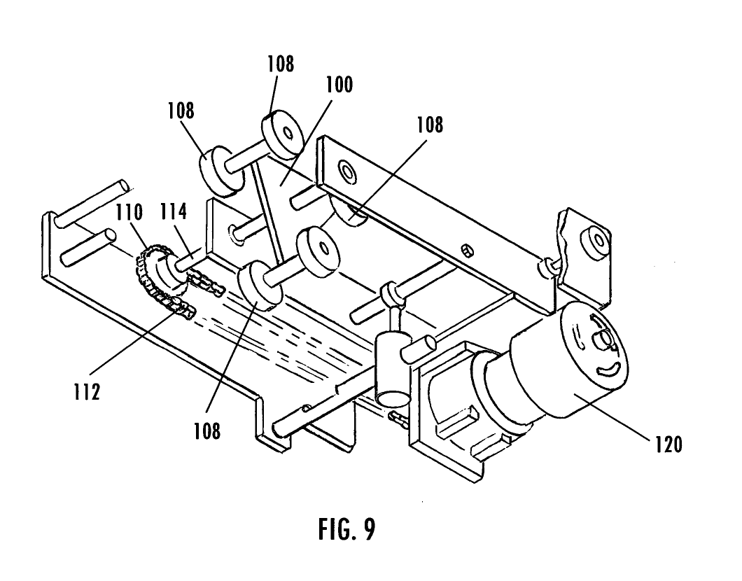

In addition to the inversion of the user, a roller member 100 shown in FIG. 9 is mounted on the support system 15 and underneath the cushions 30 to massage the user's spine and spinal cord. Accordingly the cushions 30 are in between the roller member 100 and the user of the table. The roller system has at least one roller 108 and the preferred embodiment has three pairs of rollers 108 spaced in a triangular pattern around an axis of the roller member 100. The axis is preferably perpendicular to the longitudinal axis of the support system 15. The pairs of rollers 108 can be rotated around the axis of the roller member 100. When activated by the user or a third party by use of controls which can be mounted on the table 20, the pairs of rollers 108 rotate around the axis and push against the cushions 30 and therefore press on the user's spine and vertebrae. As shown in FIG. 9, gears 110 can be used along with a chain 112 driven by a motor 120 to rotate shaft 114 which then rotate the rolling member 100. The height of the rollers 108 relative to the cushion 30 can be changed, therefore an increasing or decreasing amount of pressure can be put on the user.

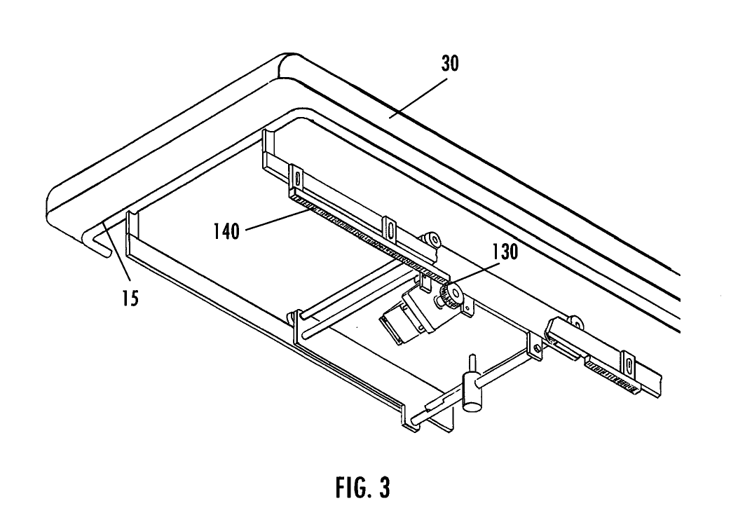

In addition to the rotational movement of the rollers 108, the roller member 100 can also travel on a longitudinal path parallel to the user's spine when on the table 20. The roller member travels via a linear path from the first end 21 to the second end 22 which can correspond to the length of the user's spine. A set of gears 130 allows the roller member 100 to travel at specific increments along a linear member 140 as shown in FIG. 3. Again, the linear movement is done via a motor and controlled by the set of controls 60. The rotational movement of the rollers 108 and the linear movement of the roller member 100 are independent of each other and can be done at the same time. Furthermore, the height of the roller member 100 can also be controlled independently of the other movements of the roller member 100 and rollers 108.

The controls of the table 20 can be utilized while the user is in a non-inverted or inverted position. If utilized in the non-inverted position, the user will be able to exit the table 20 by reversing the procedure for entering the table.

From the foregoing description it will be evident that by a single action of the practitioner, the table will tilt and elevate and the footplate will be properly positioned. Having thus described the invention in connection with the preferred embodiments thereof, it will be evident to those skilled in the art that various revisions can be made to the preferred embodiments described herein without departing from the spirit and scope of the invention. It is my intention, however, that all such revisions will be included within the scope of the following claims.

What is claimed is:

1. A chiropractic table, comprising:
a frame;
the frame comprising a first end and an opposite second end;
at least one supporting member;
the at least one supporting member extending from the frame;
a patient support system;
the patient support system comprising a first end and a second end;
the patient support system mounted on a second frame;
the second frame connected to the at least one supporting member;
a foot support;
the patient support system rotatable around the at least one supporting member;
the first end of the patient support system is positioned above the second end of the patient support system when the table is in a first position;
the first end of the patient support system is positioned below the second end of the patient support system when the table is in a second position, thereby at least partially inverting the patient support system and thereby at least partially inverting a user of the chiropractic table.

2. The invention of claim 1, further comprising:
a first power driven mechanism adapted to move the table to and from the first position to the second position.

3. The invention of claim 2, further comprising:
a roller member;
the roller member comprising at least one roller;
the roller member located under the patient support system;
the roller member having an axis of rotation;
the at least one roller rotatable around the axis of rotation wherein the at least one roller selectively contacts with the patient support system thereby making contact with a portion of a user of the table and massaging said user.

4. The invention of claim 3, further comprising:
a longitudinal frame;
the longitudinal frame perpendicular to the axis of rotation;
the roller member movable along the longitudinal frame in increments.

5. The invention of claim 4, wherein:
the first power driven mechanism tilts the patient support frame from about 45 degrees from the horizontal to about 135 degrees from the horizontal.

6. The invention of claim 5, wherein:
the roller member has a plurality of rollers.

7. The invention of claim 6, further comprising:
a footplate mounted to the patient support frame at the second end;
the footplate can selectively secure the feet of the user of the table whereby the user will be able to maintain a particular position relative to the table.

8. The invention of claim 7, further comprising:
a lever attached to the footplate;
whereby manipulation of the lever selectively opens and closes a pair of leg capturing members.

9. The invention of claim 7, wherein:
the pair of leg capturing members are padded;
the pair of leg capturing members contain a curved portion corresponding to fit around the legs of an individual using the invention.

10. A chiropractic table, comprising:
a frame;
a patient support system connected to the frame;
the patient support system pivotable on frame;
the patient support system comprising a first end and a second end;
whereby the first end accommodates the head of a user of the table and the second end accommodates the user's legs;
whereby the table has a first position in which the user's head is above the user's legs;
whereby the table has a second position in which the user is at least partially inverted.

11. The table of claim 10, further comprising:
a support member;
the support member substantially perpendicular to a longitudinal axis of the patient support system;
the patient support system rotatable around an axis of the support member.

12. The table of claim 11, further comprising:
at least one roller movable upon the longitudinal axis of the patient support system whereby the at least one roller massages the back of a user of the table.

13. The table of claim 12, wherein:
the at least one roller is mounted to a roller member;
the roller member having an axis;
the at least one roller rotatable around the axis.

14. The table of claim 13, wherein:
the longitudinal movement of the at least one roller is independent of the movement of the rotational movement of the at least one roller.

15. The table of claim 14, wherein:
the longitudinal movement of the at least one roller is driven by a first power mechanism.

16. The table of claim 15, wherein:
the rotational movement and the longitudinal movement of the at least one roller is selectively controlled by the user and can be achieved while the table is in an inverted and non-inverted position.

17. The table of claim 16, wherein:
the roller member has a plurality of rollers.

18. The table of claim 17, further comprising:
a footplate mounted to the patient support system;
a lever attached to the footplate;
whereby manipulation of the lever selectively opens and closes a pair of leg capturing members.

19. The table of claim 18, wherein:
the pair of leg capturing members are padded;
the pair of leg capturing members contain a curved portion corresponding to fit around the legs of an individual using the invention.

20. A chiropractic table, comprising:
a frame;
a patient support system;
the patient support system pivotally attached to the frame;
the patient support system having a first end and a second end;
whereby the first end accommodates an upper half of a user of the table and the second end accommodates a lower half of the user of the table;
the table has a first position whereby the user's upper half is located above the user's lower half;
the table has a second position whereby the user is inverted whereby the user's lower half is located above the user's upper half;
a roller member containing a plurality of rollers;
the roller member movable upon a longitudinal axis of the patient support system whereby the rollers can massage the user's back;
the rollers rotatable on an axis of the roller member;
the roller member movable in relation to a plane of the patient support system whereby an amount of force on the user by the rollers can be controlled;
a footplate;
a lever attached to the footplate;
whereby manipulation of the lever selectively opens and closes a pair of leg capturing members.
